(19) United States
(12) Patent Application Publication
(10) Pub. No.: US 2005/0234858 A1
(43) Pub. Date: Oct. 20, 2005

(54) Recording and reproducing apparatus, reproducing apparatus, recording and reproducing method, reproducing method, program and recording medium

(76) Inventors: Yasuyuki Torii, Kyoto (JP); Nobuyasu Takeguchi, Osaka (JP); Hiroshi Kase, Osaka (JP); Kevin Leigh La Chapelle, Redmond, WA (US); Ian Cameron Mercer, Sammammish, WA (US); Brian James Walker, Duvall, WA (US)

Correspondence Address: RATNERPRESTIA, P O BOX 980, VALLEY FORGE, PA, 19482-0980, US

(21) Appl. No.: 11/090,543

(22) Filed: Mar. 25, 2005

Related U.S. Application Data
(60) Provisional application No. 60/557,650, filed on Mar. 30, 2004.

(51) Int. Cl. G06F 7/00

(52) U.S. Cl. 707/1

(57) ABSTRACT

[Object] When additional recording is performed by a recording apparatus and a program of a different method of management information construction to a recording medium having recorded thereon management information data such as a content parameter, a menu, a play list and a menu display image together with content data such as an audio, a static image and a video, consistency of the management information data is lost.

[Solution] It is possible to record in a file header portion 31 of a management information file group 2 an editor identifier 33 for identifying an apparatus and a program having edited that file, trace update history of the file with a file management device 14 and update information with a management information file creation device 15 by reflecting an intention of management information already recorded so as to keep the consistency of the management information.

### FIELD OF THE INVENTION

The present invention relates to a recording and reproducing apparatus, a reproducing apparatus, a recording and reproducing method, a reproducing method, a program and a recording medium.

### BACKGROUND OF THE INVENTION

It has traditionally been possible, on a personal computer, to select and reproduce an audio data file having music, voice, sound effects and the like recorded therein, a static image data file having photos, paintings, graphics and the like recorded therein and a video data file having movies, videos, animations and the like recorded therein as desired by a user from a recording medium on which they are stored. Such data is managed in a predetermined file system according to the recording medium, and a location thereof can be recognized on the personal computer as a file existing in a directory having a hierarchical structure.

Of these data files, a file defining a procedure for consecutively reproducing a plurality of files in specific order is generally called a play list file. There exists a system or the like which records altogether, a play list file simply having arranged character strings with a path name of the directory added before a file name (refer to Nonpatent Document 1 for instance), a play list file in an XML (eXtensible Markup Language) format describing a file name and other information together (refer to Nonpatent Document 2 for instance), and, by defining the data file with an ID number, management information such as parameter information on a content data file, menu information as a user interface, an image file used for a menu display and meta data of the content data file, in addition to the play list file (refer to Nonpatent Document 3 for instance).

If these play list files are recorded together with the data files on the recording medium such as a CD-R (Compact Disc-Recordable), the user can reproduce from desired data files in certain order just by selecting the play list file when using a player corresponding to each of the play list files for reproduction.

There is also a recording and reproducing apparatus of automatically creating the play list file by a simpler operation by using supplementary information such as an artist name accompanying the audio data file (refer to Patent Document 1 for instance).

It is possible for the user, by using a menu exploiting an image, text information as meta data and the play list, to select a classification specifically summarized out of the content data files stored in large quantity on the recording medium so as to easily locate and reproduce a desired item.

There is also a method of recording a unique identifier in order to uniquely identify an optical disc medium capable of additional recording (refer to Patent Document 2 for instance).

[Nonpatent Document 1]

A page creator of CD→WAV→MP3, “Play list,” [online], Jun. 12, 2003, [searched on Jun. 12, 2003], Internet <URL: http://www.cdwavmp3.com/player/playlist.html>

[Nonpatent Document 2]

Optical Storage Technology Association, Inc., “MPV Core Specification Revision 1.01,” [online], Mar. 11, 2003, [searched on Jun. 12, 2003], Internet <URL: http://www.osta.org/mpv/public/specs.htm>

[Nonpatent Document 3]

Reishi Asakura?, “Serial: Something is on its way ? Vol. 3,” pp. 164 to 167, Stereo Sound, June 2003, HiVi Co., Ltd.

[Patent Document 1]

Japanese Patent Laid-Open No. 2002-313070

[Patent Document 2]

Japanese Patent No. 3297333

### DISCLOSURE OF THE INVENTION

### PROBLEMS TO BE SOLVED BY THE INVENTION

A problem to be solved arises for the following reason. As a capacity of a recording medium increases and the number of content data files such as audios, static images and videos, play list files and menu files increase, adding the content data files more than once, because the capacity cannot be used up by one recording operation, requires management information such as menu information, play list information and meta data information to be updated each time. For instance, in the case of rewriting astride apparatuses having different construction algorithms and classification methods of the menu and play list, the problem is that the management information created earlier cannot be inherited and a menu configuration and a classification system of the play list originally intended collapse, which is disadvantageous to a user. For instance, in the case where the content data file is added to the recording medium including a play list information file of performing classification by artists by the recording apparatus of performing no such classification, there arises the problem that the content data file cannot be selected from the play list of the classification by artists.

### MEANS TO SOLVE THE PROBLEMS

The present invention is characterized most of all in that, as management file types, it has a content information file of putting together parameters of the content data files, a menu information file of describing menu display contents as a user interface for the sake of setting and selecting an operation procedure of content reproduction, the play list information file of defining a procedure of consecutively reproducing the content data files in specific order, a meta data information file of putting together meta data of the content data files, a menu display image file of holding together background images and thumbnail images of the play lists used for menu display, where an editor identifier for identifying a device, a system or an application which created each management information file is recorded in a file header area, for instance, of that file so as to be a keyword of tracking update history thereof.

### EFFECT OF THE INVENTION

The recording and reproducing apparatus, reproducing apparatus, recording and reproducing method, reproducing method, program and recording medium of the present invention can read the editor identifier recorded in a management information file so as to recognize whether the management information file already recorded was self-recorded and what apparatus it was recorded by. In the case where it was self-recorded, an intended edit is completed just by rewriting data of a portion to be changed when adding another content data file to the recording medium, deleting the content data already recorded or editing the menu information file and the play list information file. In the case where it was not self-recorded, it is assumed that no intended menu or play list exists and the necessary menu and play list are newly re-created by searching for the meta data information on all the contents so as to additionally rewrite them and include the menu and play list of the intended configuration.

When the management information file loses its correctness while repeating additional recording astride a plurality of recording apparatuses and reproduction can no longer be performed in an extreme case, it is possible to identify which recording apparatus has the problem by reading and displaying the editor identifier recorded in the management information file.

Furthermore, there is also an advantage that, it is possible, by having habits of each recording apparatus as a database, to recognize differences in a method of creating the management information file between the recording apparatus used for a last record on additional recording and the recording apparatus used this time to make up for insufficient information or delete unnecessary information so as to re-create the management information file of higher quality.

### DETAILED DESCRIPTION OF THE PREFERRED EMBODIMENTS

An editor identifier is recorded for the sake of identifying a device, a system or an application which created each management information file in a file header area, for instance, of that file as means of attaining an object of, even if additional recording is repeated astride a plurality of recording apparatuses, allowing creation of management information files such as a menu information file and a play list information file of an intended configuration on completion of final recording or an object of, when the management information file loses its correctness due to the additional recording, identifying the recording apparatus causing it.

Hereafter, embodiments of the present invention will be described by using FIGS. 1 to 3.

### Embodiment

First, FIG. 1 is a block diagram of a recording and reproducing apparatus according to an embodiment of the present invention. Reference numeral 1 denotes a detachable recording medium, 2 denotes a content data file group which is a group of content data files held by the recording medium 1, 3 denotes an audio data file which is an element of the content data file group 2, 4 denotes a static image data file which is an element of the content data file group 2, 5 denotes a video data file which is an element of the content data file group 2, 6 denotes a management information file group which is a group of the management information files held by the recording medium 1, 7 denotes a content information file, as an element of the management information file group 6, of putting together parameters of the content data files, 8 denotes a menu information file, as an element of the management information file group 6, of describing menu display contents as a user interface for the sake of setting and selecting an operation procedure of content reproduction, 9 denotes a play list information file, as an element of the management information file group 6, of defining a procedure of consecutively reproducing the content data files in specific order, 10 denotes a meta data information file, as an element of the management information file group 6, of putting together meta data of the content data files, 11 denotes a menu display image file, as an element of the management information file group 6, of holding together background images and thumbnail images of the play lists used for menu display, 12 denotes the recording and reproducing apparatus of the present invention, 13 denotes controlling means of managing and creating file information and controlling other blocks in the recording and reproducing apparatus 12, 14 denotes file management means of managing all the file information and displayed menu information in the controlling means 13, 15 denotes management information file creation means of creating the management information file in the controlling means 13, 16 denotes internal storage means of holding the content data file group and other information files to be recorded on the recording medium 1 inside the recording and reproducing apparatus 12, 17 denotes a content data file held by the internal storage means 16, 18 denotes a by-editor identifier error information file which is characteristic information in creating the management information of the recording and reproducing apparatuses classified by using as items editor identifiers described in the files of the management information file group 6, 19 denotes file recording means of recording the management information file created by the management information file creation means 15 and the content data file 7 on the recording medium 1, 20 denotes file reading means of reading the content data file group 2 and the management information file 6 from the recording medium 1, 21 denotes content data file decoding means of decoding the content data file read by the file reading means 20, 22 denotes menu display means of displaying and informing the user of an operating status of the recording and reproducing apparatus 5, a menu on reproducing the content data file and mismatching contents, a mismatching file or the editor identifier having caused a mismatch when the management information file is abnormal 23 denotes operation input means of operating the menu and providing an instruction for an operation of the recording and reproducing apparatus 5, and 24 constitutes content data file encoding means of encoding the content data file to be stored in the internal recording means 16 or recorded on the recording medium 1 by the file recording means 19.

Here, the recording medium 1 has a detachable configuration. However, it may also have the configuration in which it is the recording medium built into the recording and reproducing apparatus and is able to take in or read each file to be held from the apparatus connected to the outside of the recording and reproducing apparatus or a communication path. To be more precise, the recording medium 1 has an optical disc such as CD-R/-RW, DVD-RAM/-R/-RW/+R/+RW, a removable HD (Hard disk), a flash memory, a server connected to a network and the like.

To be more precise, the controlling means 13 has a CPU (Central Processing Unit), a built-in microcomputer and the like.

Then, FIG. 2 is an explanatory diagram of a management information file 30 according to an embodiment of the present invention, wherein reference numeral 31 denotes a header portion of storing type information on the management information file, various supplementary information on the data files included therein, the number of the management information files and the like, 32 denotes a data portion of storing the data itself in various management information files, and 33 constitutes the editor identifier which is assigned to a predetermined area of the header portion 31 and is identification information on names and codes of the apparatus and application having created each management information file.

Then, FIG. 3 is a processing flow diagram of the recording and reproducing apparatus 12 showing how to process the management information in the case where there is a mismatch as a result of checking consistency of the contents of all the information on reading the management information files and the file system of the recording medium according to the embodiment of the present invention,

Next, a description will be given as to the operation of checking logical consistency of the management information file stored in the recording medium, the file system of the recording medium or the content data file and operating the management information file according to the results thereof, before the operation of reproducing the content data file recorded on the recording medium, editing it by deleting or dividing it or newly recording it in addition by using the flow diagram in FIG. 3 of checking and correcting the contents of the management information file.

The content data file group 2 comprised of one or more data files of the audio data file 3, the static image data file 4 and the video data file 5, and the management information file group 6 comprised of one or more information files of the content information file 7 of putting together parameters of the content data files, the menu information file 8 of describing the menu display contents as the user interface for the sake of setting and selecting the operation procedure of the content reproduction, the play list information file 9 of defining a procedure of consecutively reproducing the content data files in specific order, the meta data information file 10 of putting together the meta data of the content data files, the menu display image file 11 of holding together the background images and the thumbnail images of the play lists used for the menu display, are assumed to be stored in the recording medium 1. Here, in the case where the user wants to perform the operation of reproducing the content data file, editing it by deleting or dividing it or newly recording it in addition by using the recording and reproducing apparatus 12, the recording and reproducing apparatus 12 first checks logical correctness of data contents of the management information file. This is intended to prevent a state in which the menu information file 8 or the play list information file 9 for performing reproduction operation is incorrect and so a selected content data file cannot be reproduced and a state in which the management information file group 6 is incorrect on performing the recording or editing operation and the management information file group having its information updated based thereon also becomes incorrect and so the reproducing operation thereafter cannot be performed as intended by the user.

On starting to check the management information in a step 40, the file management means 14 reads the management information file group 6 and file system information of the recording medium from the recording medium 1 with the file reading means 20 in processing steps 41 and 42. The information may be stored in the internal recording means 16 as required. Next, the management information file group 6 read in a branch processing step 43 is checked against the contents of the file system information of the recording medium to check whether or not there is a logical mismatch. If there is no problem, the menu display is performed in a step 50 in order to perform the operation of reproducing it, editing it by deleting or dividing it or newly recording it in addition, and it finishes the process of checking the management information in a step 51 to move on to a next process.

If there is a problem in the branch processing step 43, branching to a processing step 44 is performed to display the mismatching contents, the editor identifier 33 of a mismatching information file or a file name of the mismatching information file from the menu display means 22 to inform the user that there is an abnormality in the contents of the management information file group 6. It is possible, by displaying the editor identifier 33 of the mismatching information file, to let the user recognize which of the apparatuses or programs previously used has caused it so as to avoid repeating the same failure and promote correction of a problematic apparatus or program. Next, in a branch processing step 45, branching to four kinds of processing is performed according to the contents set up in advance as to what process should be performed on occurrence of the mismatch or by having it selected by the user then.

In the case of branching to a processing step 46, all the management information files are newly created by the management information file creation means 15. In this case, the original menu configuration and play list to be implemented by the original management information file group, the background images and thumbnail images used for menu display and the like are lost. However, it is possible, by a classification method provided to the recording and reproducing apparatus 12, to securely reconstitute the management information files with no mismatch by targeting all the content data files.

Next, in the case of branching to a processing step 47, only the management information file group having the mismatch is newly re-created by the management information file creation means 15. In this case, the original menu configuration or play list to be implemented by the re-created management information files, or the background images or thumbnail images used for menu display are lost. However, it is possible, by the classification method provided to the recording and reproducing apparatus 12, to correctly reconstitute only the management information files with the mismatch while keeping the management information files with no mismatch as-is as much as possible.

Next, in the case of branching to a processing step 48, only the management information file group having the mismatch is newly re-created by the management information file creation means 15. When performing the processing step 48, it is a precondition to have an adequate by-editor identifier error information file 18 in the internal recording means 16. The by-editor identifier error information file 18 has recorded therein a characteristic menu of by-editor identifier management information files classified by the editor identifier 33 for identifying various recording and reproducing apparatuses and programs, the configuration and classification method of the play lists, and besides, error information generated on additional recording by another recording and reproducing apparatus or program. It is possible, by referring to the by-editor identifier error information file 18, to correctly reconstitute only the management information files with the mismatch without losing the original menu configuration or play list to be implemented by the re-created management information files, or the background images or thumbnail images used for the menu display.

Next, in the case of branching to a processing step 48, the management information files are determined to be unusable while leaving the management information file group having the mismatch as-is. In this case, the content data file group is reproduced on the assumption that there is no management information file on the recording medium 1. To be more specific, directory names can be displayed based on an original menu provided to the recording and reproducing apparatus 12 such as the file system of the recording medium 1 to have a selection made by the user, and then the file names of the content data included in the directory can be displayed to have a selection made by the user. This is a possible method of narrowing down a target data file.

It is possible, by the above process, to implement the menu display with no operation problem in a processing step 50.

In the case where the content data file group 17 is held by the internal storage means 16 of the recording and reproducing apparatus 12 or in the case where the content data file encoding means 24 of capturing audios, static images and videos from the outside and encoding them in the content data file is provided, it is possible to have the content data file additionally recorded on the recording medium 1 by the file recording means 19. On performing the additional recording then, the file management means 14 checks a logical relationship among the content data file group 2, the management information file group 6 and the file system already held by the recording medium 1. And if it determines that they are mismatching, it recovers the consistency of the management information files according to the processing flow diagram of the management information check and content correction in FIG. 3, and then additionally records a new content data file. It is thereby possible to inherit the original menu configuration and play list to be implemented by the original management information file group, the background images or thumbnail images used for the menu display and the like without any problem.

The first embodiment was described in detail above.

The program of the present invention is the program for causing a computer to execute the functions of all or a part of the means (or apparatuses) of the above-mentioned recording and reproducing apparatus and reproducing apparatus of the present invention, which is the program to operate in collaboration with the computer.

And the program of the present invention is that for causing the computer to execute the operations of all or a part of the steps of the above-mentioned recording and reproducing method and reproducing method of the present invention, which is the program to operate in collaboration with the computer.

The recording medium of the present invention is that of supporting the program for causing the computer to execute all or a part of the functions of all or a part of the means (or apparatuses) of the above-mentioned recording and reproducing apparatus and reproducing apparatus of the present invention, wherein the program is readable by the computer and the read program executes the functions in collaboration with the computer.

And the recording medium of the present invention is that of supporting the program for causing the computer to execute all or a part of the operations of all or a part of the steps of the above-mentioned recording and reproducing method and reproducing method of the present invention, wherein the program is readable by the computer and the read program executes the operations in collaboration with the computer.

The “functions of the means” of the present invention means all or a part of the functions of the means, and the “operations of the steps” of the present invention means all or a part of the operations of the steps.

A form of using the program of the present invention may be a form in which it is recorded on the recording medium readable by the computer and operates in collaboration with the computer.

Another form of using the program of the present invention may be a form in which it is transmitted in a transmission medium, is read by the computer and operates in collaboration with the computer.

The recording medium includes an ROM and the like, and the transmission medium includes the transmission medium such as the Internet, and light, a radio wave, a sound wave and the like.

The above-mentioned computer of the present invention is not limited to sheer hardware such as a CPU, but may include firmware, an OS and also peripherals.

As described above, the configuration of the present invention may be implemented either software-wise or hardware-wise.

The recording and reproducing apparatus, reproducing apparatus, recording and reproducing method, reproducing method, program and recording medium of the present invention can read the editor identifier recorded in the management information file so as to recognize whether the management information file already recorded was self-recorded and what apparatus it was recorded by. In the case where it was self-recorded, an intended edit is completed just by rewriting data of a portion to be changed when adding another content data file to the recording medium, deleting the content data already recorded or editing the menu information file and the play list information file. In the case where it was not self-recorded, as one of applicable uses, it is assumed that no intended menu or play list exists and the necessary menu and play list are newly re-created by searching for the meta data information on all the contents so as to additionally rewrite them and include the menu and play list of the intended configuration.

When the management information file loses its correctness while repeating additional recording astride a plurality of recording apparatuses and reproduction can no longer be performed in an extreme case, it is possible, as one of the applicable uses, to identify the recording apparatus which has the problem by reading and displaying the editor identifier recorded in the management information file.

Furthermore, as one of the applicable uses, it is possible, by having habits of each recording apparatus held as a database, to recognize differences in a method of creating the management information file between the recording apparatus used for a last record on additional recording and the recording apparatus used this time to make up for insufficient information or delete unnecessary information so as to re-create the management information file of higher completeness.

### BRIEF DESCRIPTION OF THE DRAWINGS

FIG. 1 is a block diagram of a recording and reproducing apparatus according to an embodiment of the present invention.

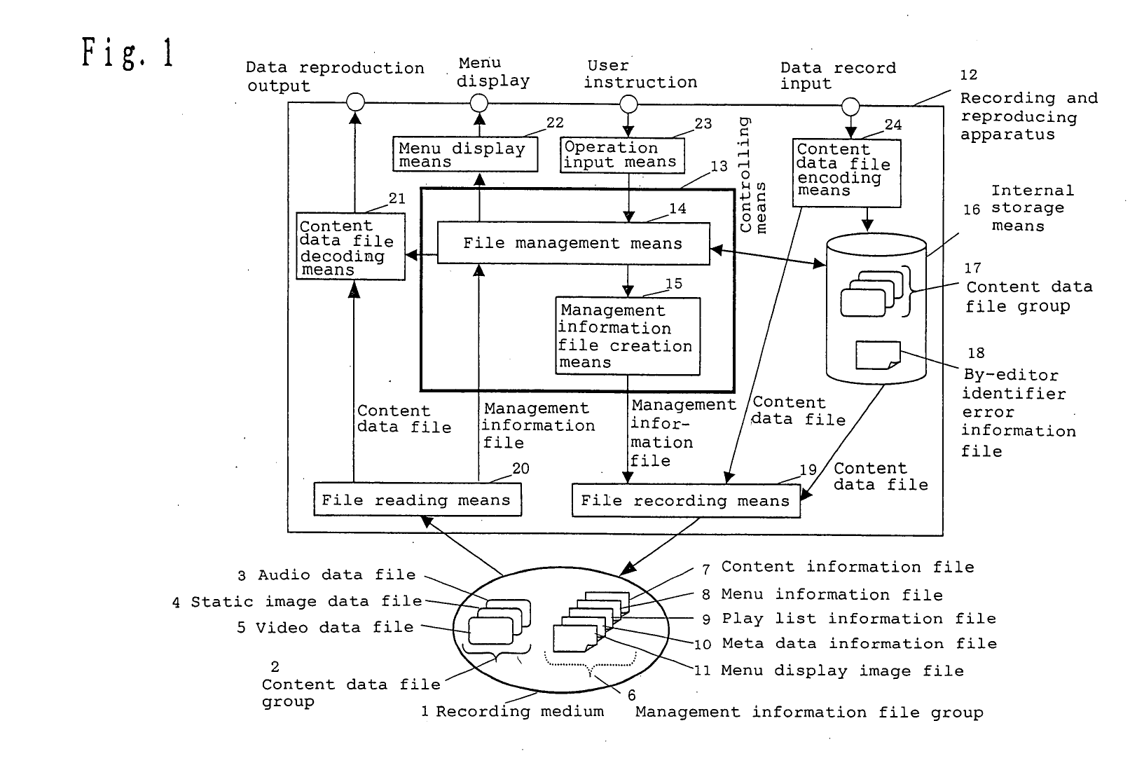

FIG. 2 is an explanatory diagram of a management information file according to the embodiment of the present invention.

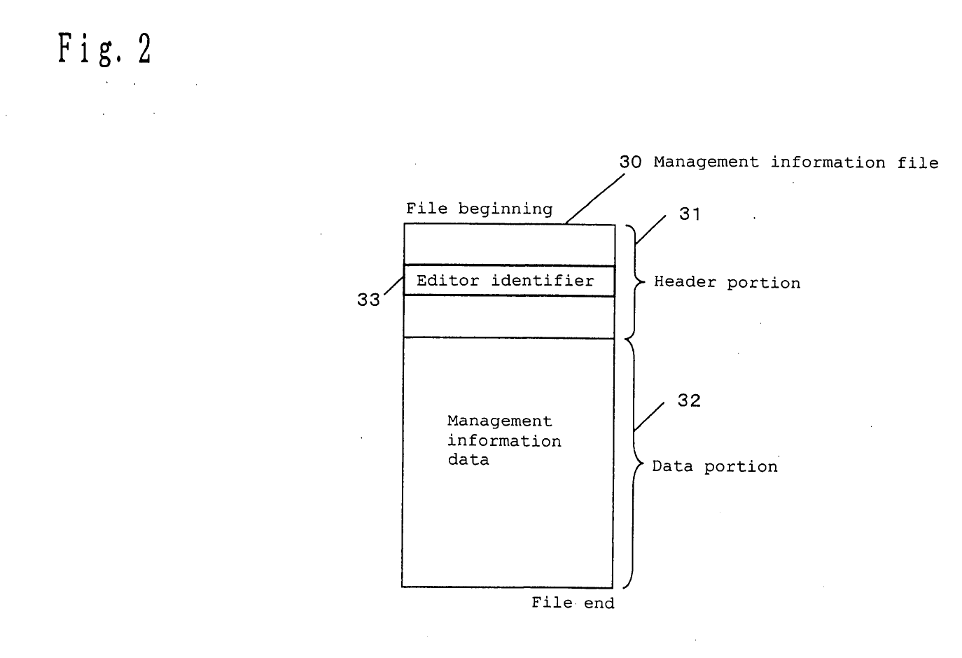

FIG. 3 is a flow diagram of management information check and content correction processes according to the embodiment of the present invention.

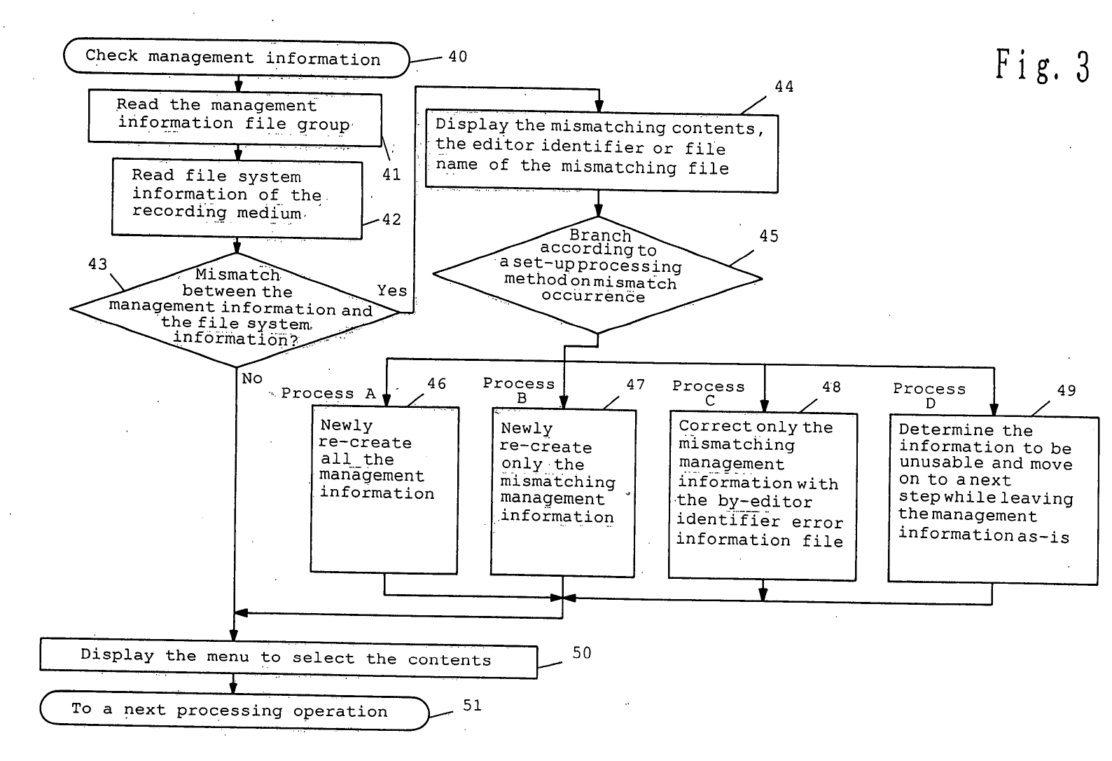

### DESCRIPTION OF SYMBOLS

1 Recording medium
2 Content data file group
3 Audio data file
4 Static image data file
5 Video data file
6 Management information file group
7 Content information file
8 Menu information file
9 Play list information file
10 Meta data information file
11 Menu display image file
12 Recording and reproducing apparatus
13 Controlling means
14 File management means
15 Management information file creation means
16 Internal storage means
17 Content data file group
18 By-editor identifier error information file
19 File recording means
20 File reading means
21 Content data file decoding means
22 Menu display means
23 Operation input means
24 Content data file encoding means

1. A recording and reproducing apparatus comprising: a recording medium including one or more content data files of storing predetermined data and one or more management information files of content information, a reproducing method and the like of the one or more content data files; file reading means of reading the content data file and the management information file from the recording medium; file recording means of recording the content data file and the management information file on the recording medium; file management means of temporarily managing the contents of a read file; and management information file creation means of creating the management information file to be recorded on the recording medium by newly creating it or correcting its contents, characterized in that: the content data file or the management information file are capable of correction recording such as additional recording, deletion or change of the contents, and the management information file has a specific area secured for the sake of recording an editor identifier for identifying a device, a system or an application which created that file.

2. The recording and reproducing apparatus according to claim 1, characterized in that types of the content data files recorded on the recording medium are multimedia contents such as audios, static images, videos and textual information.

3. The recording and reproducing apparatus according to claim 1, characterized in that the types of the management information files recorded on the recording medium are management information on a content information file of putting together parameters of the content data files, a menu information file of describing menu display contents as a user interface for the sake of setting and selecting an operation procedure of content reproduction, a play list information file of defining a procedure of consecutively reproducing the content data files in specific order, a meta data information file of putting together meta data of the content data files, a menu display image file of holding together background images and thumbnail images of the play lists used for menu display and the like.

4. The recording and reproducing apparatus according to claim 1, 2 or 3, characterized in that, in the case of additionally recording or deleting the content data file anew, the information file is not newly re-created, but the contents of one or more of the original information files are inherited and only data of a necessary area in that file is added, deleted or rewritten.

5. A reproducing apparatus comprising: a recording medium including one or more content data files of storing predetermined data and one or more management information files of content information, a reproducing method and the like of the one or more content data files; file reading means of reading the content data file and the management information file from the recording medium; file management means of temporarily managing the contents of a read file; and menu display means of displaying a menu on reproducing the content data file read from the recording medium, characterized in that: if the file management means determines that there is a mismatch in a logical relationship among the content data file held by the recording medium, the management information file and a file system of the recording medium, a most doubtful file is searched for by referring to update time information of each file and an editor identifier listed in the management information file, and the menu display means displays and informs the user of mismatching contents, a mismatching file or the editor identifier having caused the mismatch.

6. A recording and reproducing apparatus comprising: a recording medium including one or more content data files of storing predetermined data and one or more management information files of content information, a reproducing method and the like of the one or more content data files; file reading means of reading the content data file and the management information file from the recording medium; file recording means of recording the content data file and the management information file on the recording medium; file management means of temporarily managing the contents of a read file; and management information file creation means of creating the management information file to be recorded on the recording medium by newly creating it or correcting its contents, characterized in that: if the file management means determines that there is a mismatch in a logical relationship among the content data file held by the recording medium, the management information file and a file system of the recording medium, all the management information files are newly re-created.

7. The recording and reproducing apparatus according to claim 6, characterized in that, if the file management means determines that there is a mismatch in the logical relationship among the content data file held by the recording medium, the management information file and the file system of the recording medium, a most doubtful file is searched for by referring to update time information of each file and an editor identifier listed in the management information file, and only incorrect contents of the files are corrected by the management information file creation means and are rerecorded on the recording medium by the file recording means so as to recover consistency of all the files.

8. The recording and reproducing apparatus according to claim 7, comprising: a by-editor identifier error information file organized by editor identifiers and having recorded therein construction algorithms and classification methods of the menu and play list which are characteristics on creating the management information file with various apparatuses classified by each of the editor identifiers and also error information possibly generated on additional recording in the management information file created by an apparatus of insufficient compatibility; and internal storage means of holding the by-editor identifier error information file, characterized in that: if the file management means determines that there is a mismatch in the logical relationship among the content data file held by the recording medium, the management information file and a file system of the recording medium, the most doubtful file is searched for by referring to update time information of each file and an editor identifier listed in the management information file, and incorrect contents of the files are corrected to be more correct by the management information file creation means by referring to the by-editor identifier error information file and are rerecorded on the recording medium by the file recording means so as to recover consistency of all the files.

9. The recording and reproducing apparatus according to claim 8 comprising: content data file encoding means of encoding content data captured from the outside to convert it to the content data file; or the internal storage means of holding the content data file already encoded, characterized in that: when the content data file is newly recorded on the recording medium if the file management means determines, as a result of a check, that there is the mismatch in the logical relationship among the content data file already held by the recording medium, the management information file and the file system of the recording medium, incorrect contents of the files are corrected to be more correct and then the new content data file is added and the management information file is simultaneously updated in conjunction therewith so as to recover consistency of all the files.

10. A recording medium processable by a computer, characterized in that it includes one or more content data files of storing data such as audios, static images, videos and textual information, and has one or more management information files such as a content information file of putting together parameters of the predetermined one or more content data files, a menu information file of describing menu display contents as a user interface for the sake of setting and selecting an operation procedure of content reproduction, a play list information file of defining a procedure of consecutively reproducing the content data files in specific order, a meta data information file of putting together meta data of the content data files and a menu display image file of holding together background images and thumbnail images of the play lists used for menu display, and the management information file has a specific area secured for the sake of recording an editor identifier for identifying a device, a system or an application which created that file.

11. A recording and reproducing method comprising: a file reading step of reading a content data file and a management information file from a recording medium; a file recording step of recording the content data file and the management information file on the recording medium; a file management step of temporarily managing the contents of a read file; and a management information file creation step of creating the management information file to be recorded on the recording medium by newly creating it or correcting its contents, characterized in that: the management information file creation step creates for the recording medium one or more management information files such as a content information file of putting together parameters of the content data files of storing data such as audios, videos, animations and textual information, a menu information file of describing menu display contents as a user interface for the sake of setting and selecting an operation procedure of content reproduction, a play list information file of defining a procedure of consecutively reproducing the content data files in specific order, a meta data information file of putting together meta data of the content data files and a menu display image file of holding together background images and thumbnail images of the play lists used for menu display, and the created management information file has a specific area secured for the sake of recording an editor identifier for identifying a device, a system or an application which created that file.

12. The recording and reproducing method according to claim 11, comprising: a by-editor identifier error information file organized by editor identifiers and having recorded therein construction algorithms and classification methods of the menu and play list which are characteristics on creating the management information file with various apparatuses classified by each of the editor identifiers and also error information possibly generated on additional recording in the management information file created by an apparatus of insufficient compatibility; and internal storage step of holding the by-editor identifier error information file, characterized in that: if the file management step step determines that there is a mismatch in the logical relationship among the content data file held by the recording medium, the management information file and a file system of the recording medium, the most doubtful file is searched for by referring to update time information of each file and an editor identifier listed in the management information file, and incorrect contents of the files are corrected to be more correct by the management information file creation step by referring to the by-editor identifier error information file and are rerecorded on the recording medium by the file recording step so as to recover consistency of all the files.

13. A reproducing method comprising: a file reading step of reading a content data file and a management information file from a recording medium; a file management step of temporarily managing the contents of a read file; and a menu display step of displaying a menu on reproducing the content data file read from the recording medium, characterized in that: if the file management step determines that there is a mismatch in a logical relationship among the content data file held by the recording medium, the management information file and a file system of the recording medium, a most doubtful file is searched for by referring to update time information of each file and an editor identifier listed in the management information file, and the menu display step displays and informs the user of mismatching contents, a mismatching file or the editor identifier having caused a mismatch.

14. A program of the recording and reproducing method according to claim 11, comprising: the file reading step of reading the content data file and the management information file from the recording medium; the file recording step of recording the content data file and the management information file on the recording medium; the file management step of temporarily managing the contents of the read file; and the management information file creation step of creating the management information file to be recorded on the recording medium by newly creating it or correcting its contents, characterized by causing a computer to execute so that: the management information file creation step creates for the recording medium one or more management information files such as a content information file of putting together parameters of the content data files of storing the data such as the audios, static images, videos and textual information, the menu information file of describing the menu display contents as the user interface for the sake of setting and selecting the operation procedure of the content reproduction, the play list information file of defining the procedure of consecutively reproducing the content data files in specific order, the meta data information file of putting together the meta data of the content data files and the menu display image file of holding together the background images and thumbnail images of the play lists used for the menu display, and the created management information file has the specific area secured for the sake of recording the editor identifier for identifying the device, system or application which created that file.

15. A program of the recording and reproducing method according to claim 12, comprising: the by-editor identifier error information file organized by the editor identifiers and having recorded therein the construction algorithms and classification methods of the menu and play list which are characteristics on creating the management information file with various apparatuses classified by each of the editor identifiers and also the error information possibly generated on additional recording in the management information file created by the apparatus of insufficient compatibility; and the internal storage step of holding the by-editor identifier error information file, characterized by causing a computer to execute so that: if the file management step step determines that there is a mismatch in the logical relationship among the content data file held by the recording medium, the management information file and the file system of the recording medium, the most doubtful file is searched for by referring to the update time information of each file and the editor identifier listed in the management information file, and incorrect contents of the files are corrected to be more correct by the management information file creation step by referring to the by-editor identifier error information file and are rerecorded on the recording medium by the file recording step so as to recover the consistency of all the files.

16. A program of the reproducing method according to claim 13, comprising: the file reading step of reading the content data file and the management information file from the recording medium; the file management step of temporarily managing the contents of the read file; and the menu display step of displaying the menu on reproducing the content data file read from the recording medium, characterized by causing a computer to execute so that: if the file management step determines that there is a mismatch in the logical relationship among the content data file held by the recording medium, the management information file and the file system of the recording medium, the most doubtful file is searched for by referring to the update time information of each file and the editor identifier listed in the management information file, and the menu display step displays and informs the user of the mismatching contents, the mismatching file or the editor identifier having caused the mismatch.
